(19) United States
(12) Patent Application Publication
(10) Pub. No.: US 2020/0167801 A1
(43) Pub. Date: May 28, 2020

(54) SYSTEM AND PROCESS FOR TRACKING E-COMMERCE CUSTOMER CLAIMS AND IDENTIFYING PATTERNS OF POTENTIAL CLAIM ABUSE

(71) Applicant: Jon P. Roberts, Salt Lake City, UT (US)

(72) Inventor: Jon P. Roberts, Salt Lake City, UT (US)

(73) Assignee: Open Think Group Inc, Salt Lake City, UT (US)

(21) Appl. No.: 16/660,451

(22) Filed: Oct. 22, 2019

Related U.S. Application Data
(60) Provisional application No. 62/772,232, filed on Nov. 28, 2018.

(51) Int. Cl. G06Q 30/00; G06Q 10/08

(52) U.S. Cl. CPC G06Q 30/0185; G06Q 10/0837

(57) ABSTRACT

A system and process for tracking e-commerce customer claims and identifying patterns of potential claim abuse is disclosed. The system and process for tracking e-commerce customer claims and identifying patterns of potential claim abuse includes a database to track e-commerce customer claims and a reporting tool. The system and process for tracking e-commerce customer claims and identifying patterns of potential claim abuse creates a type of reporting agency for online retailers to report claims to much like the consumer credit reporting bureaus have about financial history on consumers. Information may be shared by members of a given retail platform or across a number of platforms. This system may be implemented by a third party or by a selling platform and may be used to also evaluate potential breaches in return policies or delivery issues.

### CROSS-REFERENCES TO RELATED APPLICATIONS

This Application claims priority as a non-provisional perfection of prior filed U.S. Application No. 62/772,232, filed Nov. 28, 2018, and incorporates the same by reference in its entirety herein.

### FIELD OF THE INVENTION

Embodiments of the invention described in this specification relate generally to e-commerce-based systems, and more particularly, to a system and a process for tracking ecommerce customer claims and identifying patterns of potential claim abuse.

### BACKGROUND OF THE INVENTION

Tracking e-commerce claims by customers is not available by the conventional tracking systems of the day. Specifically, existing credit card fraud systems do not track customer e-commerce claim history. This is a problem because many scammers and abusers repeatedly make claims of problems in the delivery of or state of e-commerce ordered/delivery products. While many examples of e-commerce fraud and abuse exist, it commonly occurs by scammers and abusers claiming an e-commerce ordered product (or product ordered online or over the phone) was lost during delivery, damaged when it was delivered, or the wrong item was delivered to the purchaser.

This creates a major problem for online retailers who depend entirely or almost entirely on e-commerce transactions and have growing e-commerce claims being made. One of the biggest problems is that such e-commerce businesses are loathe to challenge a customer who makes an e-commerce claim. The prospect of negative reviews renders many ecommerce businesses helpless in dealing with potential e-commerce claim abuse. As result, most e-commerce businesses attempt to proactively handle any e-commerce claims by replacements, refunds, etc., without any investigation or even any questions asked. This mindset creates great costs to the retailer in the form of return shipping costs, additional labor, and leaves the retailer vulnerable to fraud. This dynamic (in which consumers of e-commerce goods hold almost all the power when it comes to e-commerce claims) has created an urgent need to find ways to filter legitimate e-commerce claims from potentially abusive or unwarranted e-commerce claims.

Therefore, what is needed is a way to report and track e-commerce customer claims to allow for potential abusive claiming patterns to be identified by e-commerce businesses and online retailers.

### SUMMARY OF THE INVENTION

A novel system and process for tracking e-commerce customer claims and identifying patterns of potential claim abuse is disclosed. In some embodiments, the system and process for tracking e-commerce customer claims and identifying patterns of potential claim abuse stores tracked e-commerce transaction and buyer history in a database. In some embodiments, the system and process for tracking e-commerce customer claims and identifying patterns of potential claim abuse creates a reporting agency for online retailers to report ecommerce customer claims and develop an e-commerce customer claim history on consumers. In some embodiments, the system and process for tracking e-commerce customer claims and identifying patterns of potential claim abuse includes steps for collecting and sharing claim data. In some embodiments, the system and process for tracking e-commerce customer claims and identifying patterns of potential claim abuse provides a reporting tool that allows an online retailer to determine the worthiness of a particular e-commerce customer claim viewed in light of a history of transactions for a particular customer.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flow chart depicting the initial, information gathering, stage of the invention.

FIG. 2 is a flow chart depicting the later, evaluation, stage of the invention.

FIG. 3 is a flow chart depicting an after-sale fraud detection embodiment of the invention.

FIG. 4 is a flow chart depicting the invention as a third-party provided service.

### DETAILED DESCRIPTION OF PREFERRED EMBODIMENTS OF THE INVENTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel system and process for tracking e-commerce customer claims and identifying patterns of potential claim abuse. In some embodiments, the system and process for tracking e-commerce customer claims and identifying patterns of potential claim abuse stores tracked e-commerce transaction and buyer history in a database. In some embodiments, the system and process for tracking e-commerce customer claims and identifying patterns of potential claim abuse creates a reporting agency for online retailers to report e-commerce customer claims and develop an e-commerce customer claim history on consumers. In some embodiments, the system and process for tracking e-commerce customer claims and identifying patterns of potential claim abuse includes steps for collecting and sharing claim data. In some embodiments, the system and process for tracking e-commerce customer claims and identifying patterns of potential claim abuse provides a reporting tool that allows an online retailer to determine the worthiness of a particular e-commerce customer claim viewed in light of a history of transactions for a particular customer. In some embodiments, the collected and shared claim data can be merged in with credit bureaus.

As stated above, tracking e-commerce claims by customers is not available by the conventional financial tracking systems that exist today. Specifically, existing credit card fraud systems do not track e-commerce customer claim history. This is a problem because many scammers and abusers repeatedly make claims of problems in the delivery of or state of ecommerce ordered and delivered products. While many examples of e-commerce fraud and abuse exist, it commonly occurs by scammers and abusers claiming an e-commerce ordered product (or product ordered online or over the phone) was lost during delivery, damaged when it was delivered, or the wrong item was delivered to the purchaser. This creates a major problem for e-commerce businesses and online retailers who depend entirely or almost entirely on ecommerce transactions and have growing e-commerce customer claims being made. One of the biggest problems is that such e-commerce businesses and online retailers are loathe to challenge a customer who makes an e-commerce claim. The prospect of negative reviews renders many ecommerce businesses and online retailers helpless in dealing with potential e-commerce customer claim abuse. As result, most e-commerce businesses and online retailers attempt to proactively handle any e-commerce customer claims by replacements, refunds, etc., without any investigation or even any questions asked. The dynamic in which consumers hold almost all the power when it comes to e-commerce customer claims has created an urgent need to find ways to filter legitimate e-commerce customer claims from potentially abusive or unwarranted ecommerce customer claims. One way is to avoid entering into a potentially fraught transaction in the first place.

Embodiments of the system and process for tracking e-commerce customer claims and identifying patterns of potential claim abuse described in this specification solve such problems by pooling e-commerce order data and subsequent e-commerce customer claims in a database. This database can give online retailers and e-commerce businesses more historical information pertaining to e-commerce customer claims from a particular customer, household, address, etc.

Embodiments of the system and process for tracking e-commerce customer claims and identifying patterns of potential claim abuse described in this specification differ from and improve upon currently existing financial abuse detection systems.

Some embodiments differ by tracking shipping address (where e-commerce orders are shipped to). Tracking by shipping address is more accurate then tracking by email address or even tracking by purchaser name, because email addresses can be generally created quickly and cheaply, with no way to identify the actual person associated with the email address, and a name can be anything, even when the billing information has a different name or a history at a particular address is connected with a different name. For example, a person can order 100 widgets to their home address to be delivered to JOHN DOE, instead of to their actual name, and may create a new email address that is only used for this single transaction. Credit card information could be used, but identities may be stolen, and sellers may not have actual credit card information in light of newer payment applications which handle money transfer, such as PAYPAL or VENMO.

In addition, some embodiments of the system and process for tracking ecommerce customer claims and identifying patterns of potential claim abuse improve upon the currently existing options because credit card fraud is only a single method for protecting ecommerce retailers, but does not give a complete picture in terms of e-commerce transactions from the time of order through delivery and thereafter. Instead, customer history provides a better overall picture. Thus, by creating a type of reporting agency for online retailers to report ecommerce customer claims and storing customer history in a database, there is greater chance to identify patterns of e-commerce customer claim abuse. When such a pattern of claim abuse is identified, then, an online retailer can make informed decisions about how to handle a new ecommerce customer claim.

The system and process for tracking e-commerce customer claims and identifying patterns of potential claim abuse of the present disclosure may be comprised of the following elements:

1. Collect online/e-commerce order information;

2. Collect e-commerce customer claim information about an online/ecommerce order; and

3. Track e-commerce customer claim data and use in a reporting tool.

This list of possible constituent elements is intended to be exemplary only and it is not intended that this list be used to limit the system and process for tracking ecommerce customer claims and identifying patterns of potential claim abuse of the present application to just these elements. Persons having ordinary skill in the art relevant to the present disclosure may understand there to be equivalent elements that may be substituted within the present disclosure without changing the essential function or operation of the system and process for tracking e-commerce customer claims and identifying patterns of potential claim abuse.

The various elements of the system and process for tracking e-commerce customer claims and identifying patterns of potential claim abuse of the present disclosure may be related in the following exemplary fashion. It is not intended to limit the scope or nature of the relationships between the various elements and the following examples are presented as illustrative examples only. The first collects the necessary information about a transaction being conducted and information is stored. The second element is a reporting feature about claims associated with an order. The third is the combination of #1 and #2 providing historical reference on a customer/address or household.

The system and process for tracking e-commerce customer claims and identifying patterns of potential claim abuse of the present disclosure generally works by tracking and recording transactions and e-commerce customer claims. When such information is stored in the database, the customer history can be reviewed, and worthiness can be determined. In this way, online retailers are empowered by the e-commerce customer claim tracking information, thereby allowing them to make decisions about who to do business with.

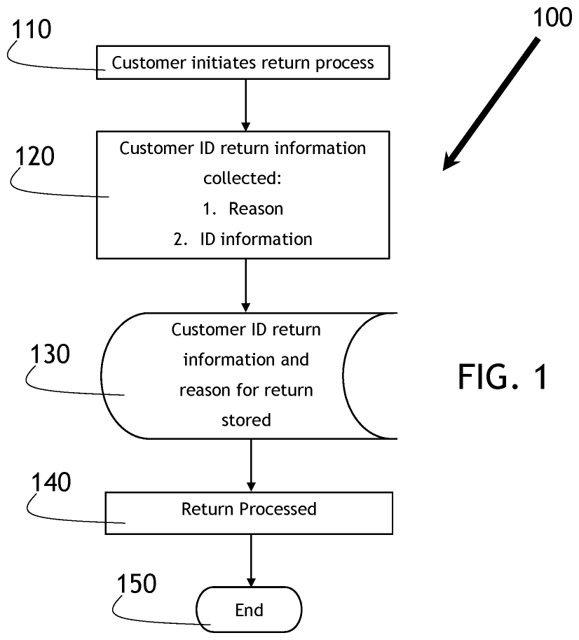

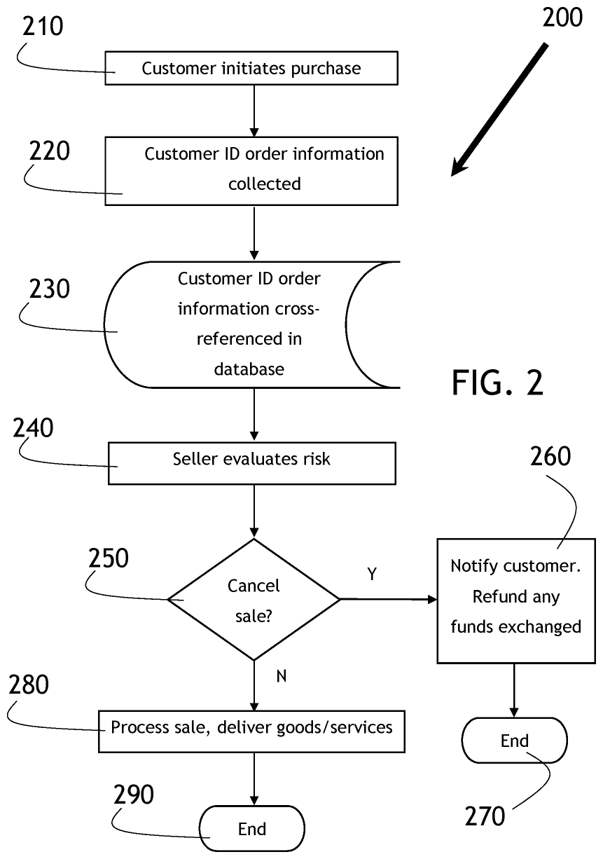

The system and process may be conceptualized as two systems working in conjunction with each other, as illustrated in FIGS. 1 and 2. In FIG. 1, a collection procedure and system 100 initiates when a customer wishes to process a return 110. Customer data is collected 120 and stored in a searchable database 130. The customer data may include any data considered relevant. As stated before, one potential element of customer data that is rarely changed is the shipping address, as most people will continue to ship to the same set of addresses, such as a home or business address or a family member's, but may change the customer name or email address rather easily. This is simply realized—if someone desires to defraud a company by exploiting their return policy, they must receive the goods in order to return them. It must be remembered that the primary function of the invention is to provide information to a vendor before an order is completed. As such, information must be gathered, catalogued, and stored in a retrievable manner. This information may be shared across a retail platform or a number of retail platforms, conglomerating more and more information in order to improve accuracy. While many embodiments of the invention may utilize information after the event of a sale, the first purpose of the invention is to provide enough information to a vendor to make an informed decision and potentially avoid fraudulent transactions before entering into them. This stage of the procedure is strictly information gathering, the return is processed 140 and the procedure ends 150.

An evaluation procedure 200 is shown in FIG. 2, where an order is placed by a consumer 210 and information gathered 220. The gathered information is then searched and compared 230 to information in the database generated in FIG. 1. At this point, the seller has information in which evaluate risk 240 and make an informed decision to continue with the sale 250. Should the seller decide not to continue, the sale may be cancelled, including the return of any funds exchanged 260, and the process ends 270. The seller may, of course, continue with the sale and fulfil the order 280, ending the process. In the latter case, loss amelioration occurs as the seller has a chance to evaluate the business worthiness of the customer before deciding to proceed with the sale and lessen the seller's risk.

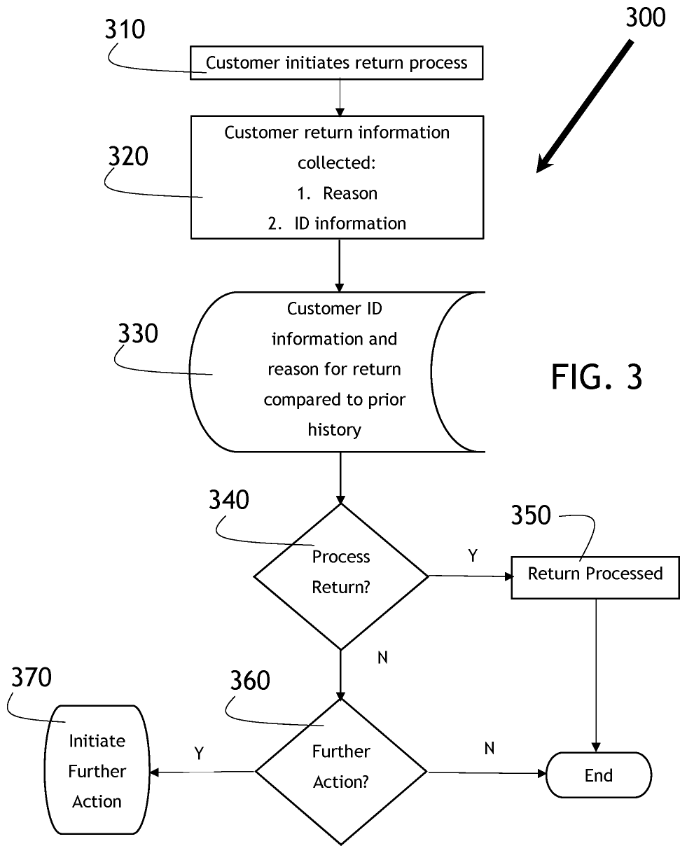

It should be noted that after a database is generated, reference to the database may occur during a return phase 300. In this event, shown in FIG. 3, after initiating a return 310, a customer's identifying information may be collected 320 and coupled with reasons for the return and the seller, who is now being asked to accept unsuitable goods, can compare previous history and identify patterns which may be indicative of violations of their return policy or may identify a particular address as having increased activity 330. After this investigation is made 340, the seller may decide to continue with the return 350 or deny the return 360 and possibly initiate further action 370, which may include alerting authorities to potential problems which may or may not be within the control of the customer.

It should also be noted that information that is cross-checked is not limited to simply the delivery address. Names, credit card numbers, and e-mail addresses may still be used as secondary identifiers to determine risk. By using secondary identifiers, there is a chance of catching somebody who has just moved or has otherwise established a second shipping address. There is also the chance of someone else moving to a new address and being turned down because of previous occupants. Cross-checking secondary information can verify when this scenario is likely to have occurred. It can also tie a secondary identifier with previous addresses to further refine reported results.

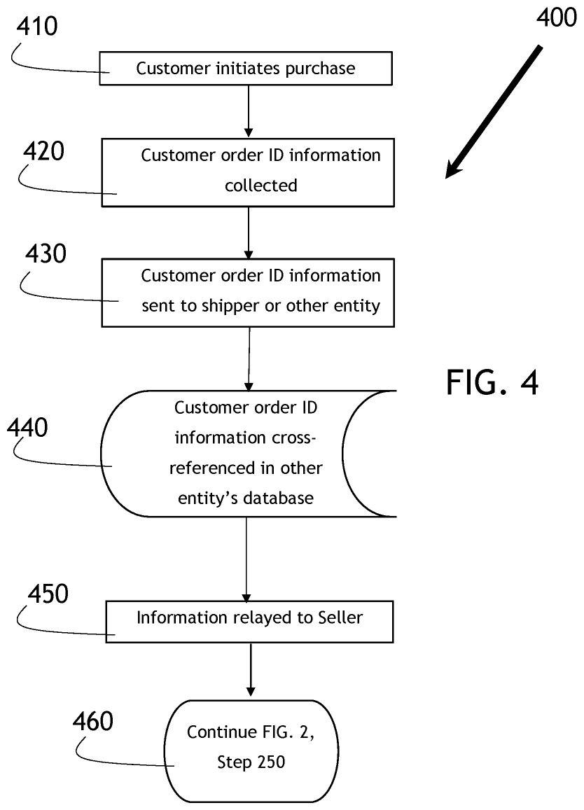

It should also be noted that the method and collected data can be leveraged into an add-on service by shipping providers, as shown in FIG. 4. Shipping providers typically have most or even all the requisite primary and secondary identifiers that would be used in the method and can easily compile a database noting a risk of return. Once a purchase is initiated 410 and information taken 420, it may then be sent to the shipper or other entity, such as the selling platform on which the sale was initiated 430. The information is then compared to the third party's database 440 and a report given to the Seller 450. From here, the procedure would follow the same procedure outlined above, in FIG. 2 starting with step 250, with the seller assessing risk from the reported results.

To make the system and process for tracking e-commerce customer claims and identifying patterns of potential claim abuse of the present disclosure, one may create a web application with software to collect online order data from various sources and platforms of online retailers (e.g., such as from Shopify, Big commerce, eBay, Amazon, Etsy, etc.). Additionally, one may provide each platform an interface to report claims on related orders, such as a reporting tool. Then the database can have a scoring algorithm or system to provide retailers with a customer worthiness score.

Although the system and process for tracking e-commerce customer claims and identifying patterns of potential claim abuse of the present disclosure can work without collecting all online orders for every transaction, the nature of this information when viewed as collective information is more valuable for big data analysis and profiling for marketing. Thus, when online retailers report e-commerce customer claims, if the order data is already collected and stored in the database, then the associated database records only need to be updated. On the other hand, if the original order information is not present (or stored in the database), then the ecommerce customer claim report can provide the order details at that time. This is possible because it is not entirely necessary to have every detail about the transaction and individual line items purchased. Nevertheless, online retailers need to be able to report what a customer's claim entailed (i.e., broken, lost, damaged, wrong item, not delivered, etc.) as this pattern of behavior and activity associated with an address or a household shipping address can uncover abuse and scams being perpetrated by end consumers.

Using the system and process for tracking e-commerce customer claims and identifying patterns of potential claim abuse of the present disclosure improves over time as the tracking of e-commerce customer claims across any or all retailers are pooled/shared, such that information about any particular customer may help an online retailer to decide whether to do business with this customer. Those who show patterns of abuse or high frequency in claims can ultimately save the retailer by choosing to cancel and refund an order before becoming subject of a high-risk factor (loss prevention).

Additionally, with more online transactions and order data collection, it is absolutely conceivable that this information could be used for targeted marketing purposes. In some embodiments, the system and process for tracking e-commerce customer claims and identifying patterns of potential claim abuse includes steps for collecting and sharing claim data. In some embodiments, the collected and shared claim data can be merged in with credit bureaus.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims. No limitation with respect to the specific embodiments disclosed herein is intended or should be inferred.

I claim:

1. A process for tracking e-commerce customer claims comprising:
a data collection step of collecting e-commerce return information for a plurality of e-commerce transactions;
a data accumulation step of storing e-commerce information in a searchable database;
a data referencing step of taking collected e-commerce order information for a current purchase and comparing it to e-commerce return information in the storable database, creating search results;
a data reporting step of returning search results to a user entity.
wherein the user entity may use the search results to make a determination as to whether to complete a sale to a customer.

2. The process for tracking e-commerce customer claims of claim 1, the return information collected being selected from the set of return information consisting of: purchaser name, delivery address, credit card information, and e-mail address.

3. The process for tracking e-commerce customer claims of claim 2, the delivery address being considered the most primary identifying information in the database.

4. The process for tracking e-commerce customer claims of claim 1, a delivery address being considered primary identifying information in both the e-commerce return information and the e-commerce order information, such that when the search report is generated, it is primarily based on the delivery address.

5. The process for tracking e-commerce customer claims of claim 1, the process being implemented by an entity that is neither a buyer nor a seller in a transaction.

6. The process for tracking e-commerce customer claims of claim 5, the return information collected being selected from the set of return information consisting of: purchaser name, delivery address, credit card information, and e-mail address.

7. The process for tracking e-commerce customer claims of claim 6, the delivery address being considered the most primary identifying information in the database.

8. The process for tracking e-commerce customer claims of claim 5, a delivery address being considered primary identifying information in both the e-commerce return information and the e-commerce order information, such that when the search report is generated, it is primarily based on the delivery address.

9. The process for tracking e-commerce customer claims of claim 1, further comprising a step of comparing return information in the storable database to detect potential delivery problems.

10. The process for tracking e-commerce customer claims of claim 9, the return information collected being selected from the set of return information consisting of:
purchaser name, delivery address, credit card information, and e-mail address.

11. The process for tracking e-commerce customer claims of claim 10, the delivery address being considered the most primary identifying information in the database.

12. The process for tracking e-commerce customer claims of claim 9, a delivery address being considered primary identifying information in both the e-commerce return information and the e-commerce order information, such that when the search report is generated, it is primarily based on the delivery address.

13. The process for tracking e-commerce customer claims of claim 1, further comprising a step of comparing return information in the storable database to detect potential return abuse.

14. The process for tracking e-commerce customer claims of claim 13, the return information collected being selected from the set of return information consisting of: purchaser name, delivery address, credit card information, and e-mail address.

15. The process for tracking e-commerce customer claims of claim 14, the delivery address being considered the most primary identifying information in the database.

16. The process for tracking e-commerce customer claims of claim 13, a delivery address being considered primary identifying information in both the e-commerce return information and the e-commerce order information, such that when the search report is generated, it is primarily based on the delivery address.
